(19) United States
(12) Patent Application Publication
(10) Pub. No.: US 2018/0327104 A1
(43) Pub. Date: Nov. 15, 2018

(54) AIRCRAFT PROPULSION ASSEMBLY COMPRISING A FAN CONJOINTLY DRIVEN BY TWO ENGINES

(71) Applicant: Airbus Operations (S.A.S.), Toulouse (FR)

(72) Inventors: Antoine Abele, Toulouse (FR); Jean-Michel Rogero, Toulouse (FR); Julien Guillemaut, Toulouse (FR); Mathieu Belleville, Toulouse (FR)

(21) Appl. No.: 15/919,970

(22) Filed: Mar. 13, 2018

(30) Foreign Application Priority Data
Mar. 14, 2017 (FR) 1752059

(51) Int. Cl. B64D 35/08; B64D 27/10; B64D 35/02; F02C 6/02; F02C 6/20

(52) U.S. Cl. CPC B64D 35/08; B64D 27/10; B64D 35/02; F05D 2260/84; F02C 6/206; F05D 2220/323; F05D 2260/40311; F02C 6/02

(57) ABSTRACT

An aircraft propulsion assembly including a fan. It include a first engine and a second engine which are not coaxial and a mechanical energy transmission device configured to enable the fan to be conjointly rotated by the first engine and the second engine. This allows an aircraft propulsion assembly to be produced of which the fan may be positioned so as to ingest the boundary layer formed at the surface of a member of the aircraft equipped with the propulsion assembly, while allowing operating modes in the case of certain failures, and certification for commercial use of an aircraft equipped with such a propulsion assembly, to which the invention also relates.

### CROSS REFERENCE TO RELATED APPLICATION

This application claims priority to French Patent Application FR 1752059, filed Mar. 14, 2017, the entire disclosure of which is incorporated by reference herein.

### TECHNICAL FIELD

The disclosure herein relates to the field of the architecture of aircraft propulsion assemblies.

### BACKGROUND

Commercial aircraft used at present have a common general architecture with a fuselage, a wing assembly including two wings, and an aft (and/or canard) tailplane. Such aircraft include one or more propulsion assemblies, which are commonly turbojets. The propulsion assemblies can be installed in various configurations. They can for example be suspended under the wing assembly by support pylons or fixed to the aft end of the fuselage by pylons or at the level of the tailplane.

As they move through the air, the external surfaces of the aircraft influence the airflow. In particular, on movement of an aerodynamic profile in air a boundary layer is created at the surface of the aerodynamic profile. This boundary layer corresponds to the area in which the speed of flow of the airflow is slowed by the surface of the profile (or other body) because of the viscosity of air.

Aircraft propulsion assemblies are generally configured so as not to ingest the boundary layer created on a surface of the aircraft. The propulsion assemblies are therefore commonly mounted so that their air intake is situated in a free airflow, which is not or not much disturbed by the surface of the aircraft. The propulsion assemblies are generally disposed under the wings or at a distance from the fuselage in the case of a mounting in the aft portion of the aircraft.

The ingestion of the boundary layer by the propulsion assembly has a certain advantage, however, at least in theory, compared to propulsion assemblies mounted in a free airflow. Actually, when a turbojet is mounted in a free airflow, the excess kinetic energy in the jet is lost. If the propulsion unit is immersed at the heart of the slower flow in the boundary layer, there is less excess kinetic energy, and comparatively less energy is required to produce the same thrust. Moreover, the propulsion assembly feeds energy into the slipstream, which reduces drag.

Increasing the efficiency of the propulsion of aircraft in order to reduce their specific consumption (that is to say the fuel consumption per unit mass of the aircraft) is at present a major challenge.

Ingestion of the boundary layer by a propulsion assembly (generally designated by the abbreviation BLI standing for “Boundary Layer Ingestion”) is envisaged with various configurations.

Some configurations enable ingestion of the boundary layer over only a portion of the air intake area of the propulsion assembly (for example over 180°). These configurations correspond to a propulsion assembly mounted flush with the surface over which the airflow flows. Such architectures subject the blades of the propulsion assembly to high distortions, however.

A so-called pusher fuselage configuration envisaged, in which a turbojet is installed in the aft portion of the fuselage and includes a fan that surround the fuselage, enables ingestion of the boundary layer over 360° of the air intake of the propulsion assembly. Boundary layer ingestion over 360° enables boundary layer ingestion to be maximized and causes less distortion at the level of the blades of the fan of the turbojet.

However, such an architecture, including a single fan propulsion assembly around the fuselage, has the disadvantage that it cannot be approved for commercial flights because of the risk of failure of a single propulsion unit.

The disclosure herein therefore aims to propose an aircraft propulsion assembly enabling the adoption of an aircraft architecture removing at least one of the disadvantages previously mentioned.

### SUMMARY

Thus the disclosure herein relates to a propulsion assembly for aircraft including a fan, including a first engine and a second engine which are not coaxial and a mechanical energy transmission device between:
a first output shaft of the first engine and a device for driving the fan on the one hand; and
a second output shaft of the second engine and the device for driving the fan on the other hand. The transmission device is configured to allow rotation of the fan conjointly by the first engine and the second engine.

Each of the first and second engines is equipped with a backup airscrew and a disengageable drive device between the engine and its respective backup airscrew or includes a turbine able to generate thrust by post-combustion, so as to provide a backup propulsion function in the event of failure of the fan or an auxiliary propulsion function in climb phases at maximum angle of attack.

The propulsion assembly proposed by the disclosure herein enables the engines to be positioned in an undisturbed airflow whereas the fan is disposed so as to ingest the boundary layer formed at the surface of an element of the aircraft equipped with the propulsion unit. The fan can in particular be configured to ingest the boundary layer formed at the surface of an aircraft fuselage. Boundary layer ingestion over 360° of the fan enables improvement of its specific fuel consumption without the fan being subjected to a high level of distortions. The presence of two engines conjointly driving the fan enables operating modes to be envisaged in the event of certain failures and certification of the aircraft for commercial use.

According to one embodiment, the transmission device comprises a first transmission shaft connected to the first output shaft of the first engine and a second transmission shaft connected to the second output shaft of the second engine. The device for driving the fan includes a first input to which the first transmission shaft is connected, a second input to which the second transmission shaft is connected, and an output to which the fan is connected.

The transmission device can include a speed reducer.

The transmission device can include coupler or decoupler between the output shafts of the engines and the fan. The coupler or decoupler between the output shafts of the engine and the fan can include a coupling or decoupling system on each of the first and second transmission shafts.

The disclosure herein also relates to an aircraft including an oblong fuselage and including a propulsion assembly as described above, in which the fan is fixed to an aft portion of the fuselage substantially centered on a principal axis of the fuselage and the first engine and the second engine are disposed on respective opposite sides of the fuselage.

In such an aircraft, the first engine and the second engine can be fixed to a respective end of a horizontal or V-shaped tailplane. Alternatively, the first engine and the second engine can be fixed to a nacelle of the fan.

Other features and advantages of the disclosure herein will become more apparent in the following description.

### BRIEF DESCRIPTION OF THE DRAWINGS

In the appended, example drawings, given by way of nonlimiting example:

FIG. 1 represents by a theoretical diagram of the aft portion of an aircraft seen from above a first example of an aircraft propulsion assembly and its immediate environment, by way of an illustration of the disclosure herein;

FIG. 2 represents, by a theoretical diagram analogous to that of FIG. 1, the aircraft propulsion assembly according to the disclosure herein from FIG. 1 equipped with auxiliary devices;

FIG. 3 represents by a theoretical diagram analogous to that of FIGS. 1 and 2 a mode of operation of the aircraft propulsion assembly from FIG. 2 in the event of failure of its fan;

FIG. 4 represents by a theoretical diagram analogous to that of FIGS. 1 through 3 a mode of operation of the aircraft propulsion assembly from FIG. 2 in the event of failure of an engine;

FIG. 5 represents by a theoretical diagram analogous to that of FIGS. 1 to 4 a second example of a propulsion assembly according to one embodiment of the disclosure herein and its immediate environment;

FIG. 6 represents by a theoretical diagram analogous to that of FIGS. 1 to 5 a third example of a propulsion assembly according to one embodiment of the disclosure herein and its immediate environment;

FIG. 7 illustrates by a diagrammatic view in section the embodiment from FIG. 6;

FIG. 8 represents by a theoretical diagram analogous to that of FIGS. 1 to 6 a fourth example of a propulsion assembly according to one embodiment of the disclosure herein and its immediate environment; and

FIG. 9 represents by a theoretical diagram analogous to that of FIG. 8 a variant of the embodiment from FIG. 8.

### DETAILED DESCRIPTION

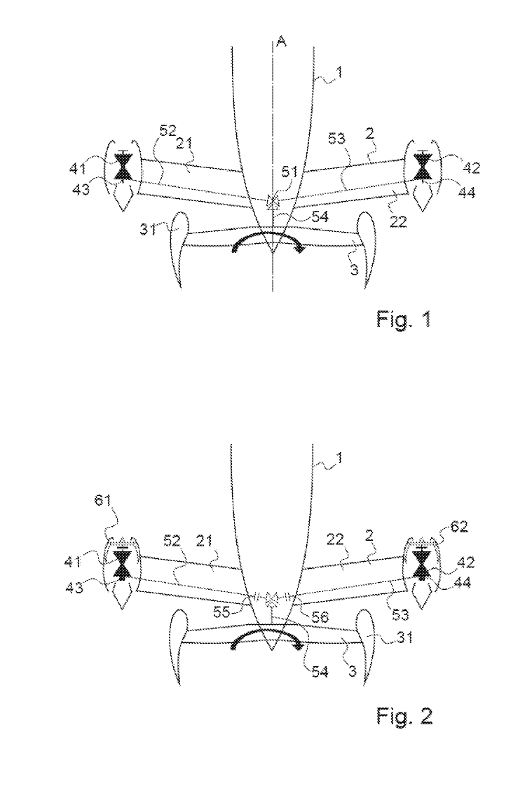

FIG. 1 represents the aft portion of an aircraft including an oblong fuselage 1, in accordance with the architecture employed at present for commercial aircraft.

At the aft end of the fuselage 1, the aircraft includes a tailplane 2, which in this instance is a horizontal tailplane also known as a stabilizer. The horizontal tailplane 2 represented here is a forward-swept tailplane. It includes a first tailplane surface 21 and a second tailplane surface 22.

In its aft portion represented here, the aircraft has a propulsion assembly including a fan 3. The fan is preferably centered or substantially centered on the principal axis A of the fuselage 1 or in the vertical median plane of the fuselage passing through the principal axis A. The fan 3 can constitute the aft end portion of the fuselage 1 or surround the fuselage. In the embodiment represented, the fan is enclosed in a nacelle 31.

The propulsion assembly includes two engines, namely a first engine 41 and a second engine 42. Each engine 41, 42 is installed at a distance from the principal axis A. The engines are at the very least non-coaxial, and for example disposed on respective opposite sides of the fuselage 1. In particular, in all the embodiments represented, each engine is installed at a distance from the principal axis (A) of the fuselage (1) greater than the radius of the fan (3). This enables aerodynamic interactions between the fan and the engines to be prevented.

In the example from FIG. 1, the first engine 41 is installed at the end of the first tailplane surface 21 and the second engine 42 is installed at the end of the second tailplane surface 22. Each engine 41, 42 can be a turbomachine.

Each engine has an output shaft. Thus the first engine 41 has a first output shaft 43 and the second engine has a second output shaft 44.

A transmission device is disposed between the output shafts 43, 44 and a mechanical input of the fan 3. The rotation of the output shafts 43, 44 drives the fan 3 in rotation. In the example represented, the transmission device includes:
an angle transmission 51;
a first transmission shaft 52 disposed between the first output shaft 43 of the first engine 41 and the angle transmission 51;
a second transmission shaft 53 disposed between the second output shaft 43 of the second engine 42 and the angle transmission 51;
a drive shaft 54 of the fan 3.

The connection between the first outlet shaft 43 and the first transmission shaft 52 is advantageously made via a for example homokinetic joint or a joint including a speed demultiplier, or a universal joint. The connection between the second output shaft 44 and the second transmission shaft 53 is advantageously identically made via a similar joint.

The transmission device enables rotation of the fan 3 conjointly by the first engine 41 and the second engine 42.

The angle transmission can simply include two input bevel gears driving a third, output bevel gear. The angle transmission can include a differential in order to allow, at least temporarily, a difference of rotation speed between the two engines 41, 42.

In all cases, the angle transmission, and more generally the transmission device, can form a speed reducer, in order to reduce the speed of and to increase the torque between the engines 41, 42 and the fan 3.

FIG. 2 shows one aspect of the embodiment from FIG. 1, equipped with devices in particular enabling protection against failure of one of the engines 41, 42 or of the fan 3. The device therefore includes a coupler or decoupler between the output shafts of the engines 41, 42 and the fan 3. In particular, the first transmission shaft 52 has a first coupling or decoupling system 55. The second transmission shaft 53 has a second coupling or decoupling system 56.

Each coupling or decoupling system 55, 56 can employ a device of known type, such as a clutch or a dog clutch coupling.

Also, the first engine 41 is equipped with a first backup airscrew 61 and the second engine 42 is equipped with a second backup airscrew 62. The backup airscrews 61, 62 are advantageously of the type that can be folded. When they are not being driven in rotation, they are folded in order to limit their aerodynamic drag. They can moreover be integrated into the fairings of the engines 41, 42 so that their impact on aerodynamic drag is nil or virtually nil.

The first backup airscrew 61 is connected to the first engine 41 by a first disengageable drive device. The second backup airscrew 62 is connected to the second engine 42 by a second disengageable drive device. The disengageable drive devices enable selective engagement of the engine with the corresponding airscrew. A speed reducer can be disposed between the engine and the corresponding backup airscrew. However, in the absence of a speed reducer, a lightweight airscrew of small diameter adapted to turn at high speed can be employed for this backup function, for which efficiency is of minor importance.

The embodiment represented in FIG. 2 enables various types of failure of the propulsion assembly to be addressed to enable the aircraft to continue its flight in a degraded mode of operation.

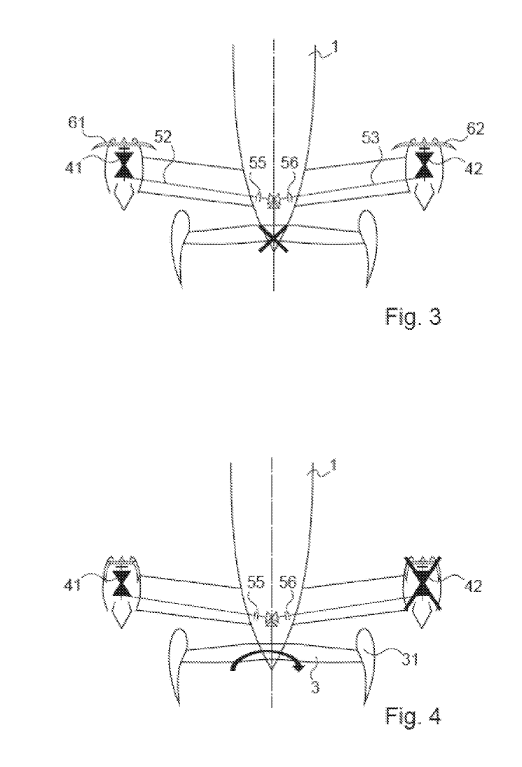

FIG. 3 illustrates the mode of operation that the propulsion assembly can adopt in the event of failure of the fan 3. Failure of the fan 3 includes for example a blade fracture. If the fan can no longer propel the aircraft, the coupling or decoupling systems 55, 56 are therefore both opened, that is to say placed in a decoupling configuration, so that the fan 3 is no longer driven by the engines 41, 42. The first and second disengageable drive devices are actuated so that the first engine 41 drives the first backup airscrew 61 in rotation and the second engine 42 drives the second backup airscrew 62 in rotation.

The decoupling of the coupling or decoupling systems 55, 56 and the coupling of the disengageable drive devices can be effected very rapidly, in a few seconds, for example in the order of three seconds, so that the aircraft can continue its flight propelled by the backup airscrews. In this operating mode, the efficiency of the propulsion assembly, and where applicable its performance, are lower than when the fan 3 is rotated by the two engines 41, 42, but the aircraft can continue its flight safely.

FIG. 4 illustrates the mode of operation that the propulsion assembly can adopt in the event of failure of one of the engines. In the example represented here, the second engine 42 is prevented from operating by a fault. The second coupling or decoupling system 56 is then opened, that is to say placed in a decoupling configuration, while the first coupling or decoupling system 55 remains closed, that is to say in a coupling configuration. Only the first engine 41 therefore drives the fan 3, while the second engine 42 that has failed is stopped and no longer takes torque away from the transmission device of the propulsion assembly.

The operating point of the first engine 41 is adapted to enable the flight of the aircraft to continue and the aircraft to land. The possibility this offers to the aircraft of flying with only one engine operational is an important element for its certification for commercial flights.

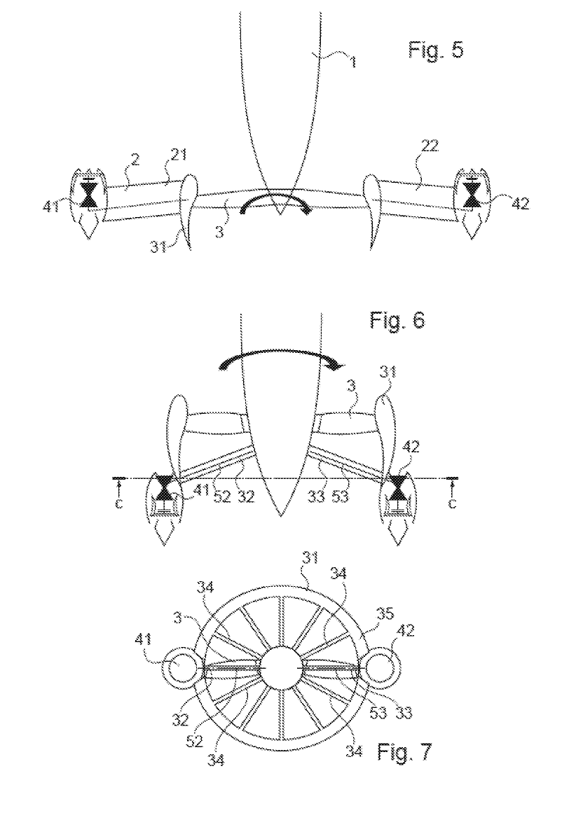

FIGS. 5 through 9 illustrate alternative embodiments of the disclosure herein. Each of these embodiments enables propulsion of the aircraft in a nominal mode, in which the first engine 41 and the second engine 42 drive the fan 3 in rotation, and in the degraded modes described above with reference to FIGS. 3 and 4.

Although coupling or uncoupling systems 55, 56 are not represented in FIGS. 5 through 9, which are aimed at presenting architectural alternatives in a general manner, such systems can be present in order to enable use of the degraded modes.

In the embodiment represented in FIG. 5, the stabilizer (horizontal tailplane 2) is fixed to the nacelle 31 of the fan 3. In particular, the horizontal tailplane 2 is composed of a first tailplane surface 21 and a second tailplane surface 22 situated on respective opposite sides of the nacelle 31 of the fan 3.

This embodiment has the advantage of eliminating aerodynamic interactions between the horizontal tailplane 2 and the fan 3. However, it necessitates a major structural adaptation of the aft portion of the aircraft that is equipped with it. Just as in the embodiment from FIGS. 1 through 4, each of the first and second engines 41, 42 is carried by a surface of the horizontal tailplane 2. In this configuration, the fan can be driven by an external ring, which simplifies the rotation of the fan and enables easy adoption of the required reduction (transmission ratio).

The embodiment from FIG. 5 can alternatively be adopted for a V-shaped tailplane 2, each of the first and second engines 41, 42 being in this case carried by a surface of the V-shaped tailplane, each of the surfaces being connected at one end to the nacelle 31.

In the embodiment represented in FIGS. 6 and 7, the first engine 41 and the second engine 42 are connected directly to the nacelle 31 of the fan 3. The engines 41, 42 being positioned in an area aft of the nacelle 31, they have backup airscrews 61, 62 in order that they do not interfere mechanically with the nacelle 31.

According to this configuration, the mechanical transmission between the engines 41, 42 and the fan 3 can be effected inside fixed blades at the outlet of the nacelle 31. Actually, in all embodiments, the nacelle 31 is advantageously provided with fixed blades enabling guidance of the airflow at the outlet of the fairing. These fixed blades are commonly referred to as OGV (Outlet Guide Vanes).

FIG. 7 represents the device from FIG. 6 in a view in section on the section plane CC represented in FIG. 6. The first transmission shaft 52 is integrated into first fixed blades 32 of the nacelle 31; the second transmission shaft 53 is integrated into second fixed blades 33 of the nacelle 31.

In the example represented here, the first fixed blades 32 and the second fixed blades 33 of the nacelle 31 extend horizontally in the nacelle 31, respectively at “nine o'clock” and “three o'clock” (taking a clock face as reference for describing the position of the fixed blades and the direction in which they extend).

The structural fixed blades 34 enable forces generated by the engines to be transferred to a principal structure of the aircraft. These forces are in particular linked to the rotation of the engines and to variations in their rotation speed, to the rotation of the transmission shafts 52, 53, and where applicable to the rotation and the traction generated by the backup airscrews 61, 62. In the example represented here there are four structural blades 34 positioned at “two o'clock”, “four o'clock”, “8 o'clock” and “ten o'clock”. The structural blades 34 are connected two by two by a structural portion 35 of the nacelle 31.

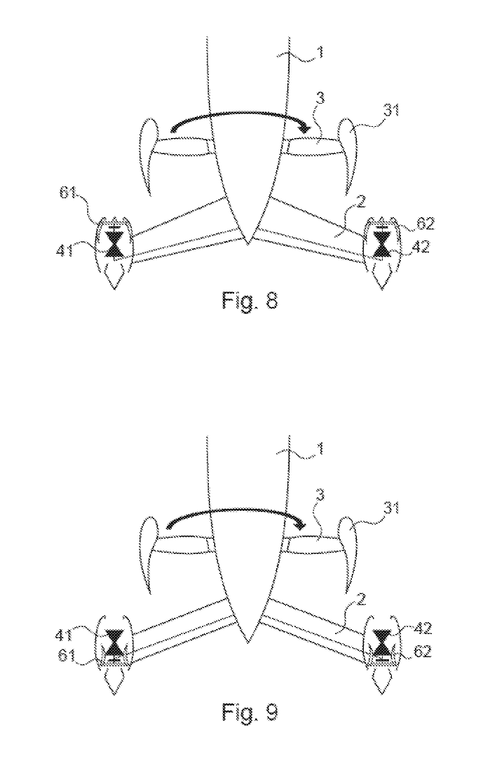

FIG. 8 and FIG. 9 respectively show an embodiment and a variant of that embodiment in which the fan 3 is positioned forward of the engines 41, 42 which are carried by a horizontal tailplane 2. The tailplane 2 can alternatively be a V-shaped tailplane. Because of its position, the tailplane 2 can bend considerably.

The configurations from FIGS. 8 and 9 have the advantage that the fan is not subjected to turbulence linked to the slipstream of the tailplane 2.

The difference between the embodiment from FIG. 8 and the variant from FIG. 9 resides in the fact that the airscrews of the variant from FIG. 9 are of the pusher type. They are installed at the rear of the engines 41, 42. An advantage of the use of pusher airscrews is that it is not necessary to provide a double output shaft for the engines. Such a shaft, which has to pass through the whole of the engine (notably the compressor when the engine is a turbomachine), leads to additional complexity of the engine.

The disclosure herein is described above according to certain nonlimiting embodiments, some features of which are interchangeable according to the required result. For example, pusher backup airscrews can be employed for the embodiment from FIG. 1 and for that from FIG. 5. Puller backup airscrews can be employed for a variant of the embodiment from FIG. 6 with the engines installed forward of the nacelle.

In all the embodiments described above including backup airscrews, when the engines include turbines, the airscrews can be replaced to provide the backup or auxiliary propulsion function by a post combustion system.

In the embodiments described above in which the engines are carried by a tailplane, the tailplane can be horizontal or V-shaped. In the embodiments in which the engines are carried by a tailplane, whether horizontal or V-shaped, the engines can be mounted at the ends of the tailplane as in the examples represented, or in an intermediate position (for example sufficient to remove the engine from the airflow aspirated or discharged by the fan, at the same time as limiting the length of the transmission shaft connected to the engine).

The use of a differential in the transmission device enables the coupling or decoupling systems of the transmission shafts to be added to or eliminated.

In addition to a turbomachine, other engine technologies can be employed, such as a piston or rotary internal combustion engine.

Although described in a variant with a fairing, the fan employed can, in all the embodiments of the disclosure herein described except for the embodiment from FIGS. 6 and 7, have no fairing (that is to say can be of the type generally designated by the expression “open rotor”).

The disclosure herein developed in this way enables the production of an aircraft propulsion assembly the fan of which can be positioned so as to ingest the boundary layer formed at the surface of an element of the aircraft equipped with the propulsion assembly, for example at the surface of an oblong aircraft fuselage, over 360°.

With the adoption of a large-diameter fan, this enables limitation of the specific consumption of the aircraft equipped with the propulsion assembly, compared to the use of two propulsion assemblies in a free airflow. The use of two engines driving the fan conjointly, or where applicable individually, enables operating modes to be envisaged in the case of some failures and certification of the aircraft for commercial use.

The aforementioned advantages can moreover be obtained with a relatively small increase of mass compared to a classic configuration employing two turbojets. Actually, as previously stated the backup airscrews can be small and light. The transmission device can include a single speed reducer instead of one speed reducer per engine. The great distance that can be adopted between the engines of the propulsion assembly moreover enables dispensing with protecting each propulsion assembly in the event of failure of the other propulsion assembly that can lead to projections outside of the engine (in a failure mode generally designated UERF “Uncontained Engine Failure”). When the propulsion assemblies are close together and/or not separated from one another by an element forming a screen, such protection is generally provided by armor plating that can have a high mass. The two fans generally employed are replaced by a single fan of larger size in order to maintain the same pressure ratio across the fan.

The use of airscrews (or where applicable post combustion) can be envisaged in climb phases at maximum angle of attack, which in a corollary manner enables limitation of the size (and the mass) of the fan. The airscrews then have the function of auxiliary airscrews, and can also as required serve as backup airscrews.

Finally, depending on the embodiment concerned, the disclosure herein can enable the provision of new functions: the use of a mechanism including gears between the engines and the fan enables rotation of the fan in reverse to be envisaged, for example for certain maneuvers of the aircraft on the ground. The proposed general configuration makes it possible to envisage orienting the airflow from the fan (or the fan itself) in order to provide a vectored thrust.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft propulsion assembly including a fan, including a first engine and a second engine which are not coaxial and a mechanical energy transmission device between:
a first output shaft of the first engine and a device for driving the fan; and
a second output shaft of the second engine and the device for driving the fan, the transmission device being configured to allow rotation of the fan conjointly by the first engine and the second engine,
wherein each of the first and second engines is equipped with a backup airscrew and a disengageable drive device between the engine and its respective backup airscrew or includes a turbine able to generate thrust by post-combustion, so as to provide a backup propulsion function in an event of failure of the fan or an auxiliary propulsion function in climb phases at maximum angle of attack.

2. The aircraft propulsion assembly according to claim 1, in which the transmission device comprises:
a first transmission shaft connected to the first output shaft of the first engine, and
a second transmission shaft connected to the second output shaft of the second engine,
the device for driving the fan including a first input to which the first transmission shaft is connected, a second input to which the second transmission shaft is connected, and an output to which the fan is connected.

3. The aircraft propulsion assembly according to claim 1, in which the transmission device includes a speed reducer.

4. The aircraft propulsion assembly according to claim 1, in which the transmission device includes a coupler or decoupler between the output shafts of the engines and the fan.

5. The aircraft propulsion assembly according to claim 4,
in which the transmission device comprises:
a first transmission shaft connected to the first output shaft of the first engine, and
a second transmission shaft connected to the second output shaft of the second engine,
the device for driving the fan including a first input to which the first transmission shaft is connected, a second input to which the second transmission shaft is connected, and an output to which the fan is connected; and
in which the coupler or decoupler between the output shafts of the engine and the fan include a coupling or decoupling system on each of the first transmission shaft and the second transmission shaft.

6. An aircraft including an oblong fuselage and including a propulsion assembly, the propulsion assembly comprising:
a fan, including a first engine and a second engine which are not coaxial and a mechanical energy transmission device between:
a first output shaft of the first engine and a device for driving the fan; and
a second output shaft of the second engine and the device for driving the fan, the transmission device being configured to allow rotation of the fan conjointly by the first engine and the second engine,
wherein each of the first and second engines is equipped with a backup airscrew and a disengageable drive device between the engine and its respective backup airscrew or includes a turbine able to generate thrust by post-combustion, so as to provide a backup propulsion function in an event of failure of the fan or an auxiliary propulsion function in climb phases at maximum angle of attack; and
the fan being fixed to a aft portion of the fuselage substantially centered on a principal axis (A) of the fuselage, and
the first engine and the second engine being disposed on respective opposite sides of the fuselage.

7. The aircraft according to claim 6, in which the first engine and the second engine are fixed to a respective end of a horizontal or V-shaped tailplane.

8. The aircraft according to claim 6, in which the first engine and the second engine are fixed to a nacelle of the fan.
